(19) United States
(12) Patent Application Publication
(10) Pub. No.: US 2021/0335334 A1
(43) Pub. Date: Oct. 28, 2021

(54) METHODS AND SYSTEMS FOR INTERACTIVE LYRIC GENERATION

(71) Applicant: WaveAI Inc., Sunnyvale, CA (US)

(72) Inventors: Margareta Ackerman, Sunnyvale, CA (US); David Loker, Sunnyvale, CA (US); Christopher Cassion, Sunnyvale, CA (US)

(21) Appl. No.: 17/232,087

(22) Filed: Apr. 15, 2021

Related U.S. Application Data
(63) Continuation-in-part of application No. 17/278,655, filed on Mar. 22, 2021.

(51) Int. Cl. G10H 1/00; G06F 3/0481; G06F 3/0484; G06N 20/00; G06N 5/04

(52) U.S. Cl. CPC G10H 1/0025; G06F 3/0481; G06F 3/0484; G06N 20/00; G10H 2250/311; G10H 2210/105; G10H 2210/111; G10H 2220/101; G06N 5/04

(57) ABSTRACT

Various embodiments of an apparatus, methods, systems and computer program products described herein are directed to a Lyric Engine. In various embodiments, the Lyric Engine receives, at a user interface, a selection of at least one song criteria. The Lyric Engine receives a first set of suggested song lyrics that correspond to the selected song criteria. The Lyric Engine presents, in the user interface, the first set of suggested song lyrics. The Lyric Engine receives, at the user interface, a selection of one or more of the suggested song lyrics in the first set. The Lyric Engine receives a second set of suggested song lyrics that correspond to the selected song criteria and the selected song lyrics. The Lyric Engine concurrently presents, in the user interface, the selected song lyrics and the second set of suggested song lyrics.

### CROSS-REFERENCE TO RELATED APPLICATIONS

This application is a Continuation-in-Part of U.S. application Ser. No. 17/278,655, filed on Mar. 22, 2021, which is a 35 U.S.C. § 371 national stage application of PCT International Application No. PCT/US2019/055934, filed on Oct. 11, 2019, which claims the benefit of U.S. Provisional Application No. 62/744,145, filed on Oct. 11, 2018, all of which are hereby incorporated by reference in their entirety.

### BACKGROUND

The current process for composing songs is entirely manual, requiring the composer to come up with all the elements of a song. The process tends to require a great deal of musical training and experience, and individuals without musical training generally cannot compose songs using the current manual methods. There is a lack of technological tools for allowing people with no musical experience to easily create original songs. For example, there do not exist tools for breaking down the composition process into smaller pieces that allow for composition by combining computer-suggested elements.

### SUMMARY

Conventional systems are deficient with respect to generating sets of suggested song lyrics according to varying levels of creativity as desired by an end user. Further, such conventional systems fail to offer the end user with selectable functionalities to continually control and modify song criteria upon which suggest song lyrics may be based.

Various embodiments of a Lyric Engine provide for significant improvements and advantages over such conventional systems with regard to generating suggested song lyrics and selecting suggested song lyrics based on one or more song criteria and types of lyric content and attributes selected by a user.

Various embodiments of an apparatus, methods, systems and computer program products described herein are directed to a Lyric Engine. In various embodiments, The Lyric Engine receives, at a user interface, a selection of at least one song criteria. The Lyric Engine receives a first set of suggested song lyrics that correspond to the selected song criteria. The Lyric Engine presents, in the user interface, the first set of suggested song lyrics. The Lyric Engine receives, at the user interface, a selection of one or more of the suggested song lyrics in the first set. The Lyric Engine receives a second set of suggested song lyrics that correspond to the selected song criteria and the selected song lyrics. The Lyric Engine concurrently presents, in the user interface, the selected song lyrics and the second set of suggested song lyrics.

In some embodiments, the Lyric Engine provides a user interface through which a user initiate a song lyric editing session to draft and edit song lyrics. In some embodiments, the user initiates drafting of song lyrics by selecting one or more song criteria such as, a genre and/or a topic for a song. The Lyric Engine presents a user interface with a plurality of suggested song lyrics that correspond to the user's selected song criteria. The user may select from the suggested song lyrics and may further edit one or more portions of the selected song lyrics. The Lyric Engine updates the user interface with additional suggested song lyrics based on the song criteria and one or more actions of the user. For example, the user may submit a word with which subsequent song lyrics should rhyme. In response to the user's submission, the Lyric Engine presents an updated listing of suggested song lyrics that rhyme with the user's submitted word.

Various embodiments include a module(s) and/or one or more functionalities to redact privacy information/data, to encrypt information/data and to anonymize data to ensure the confidentiality and security of user and Lyric Engine information/data as well as compliance with data privacy law(s) and regulations in the United States and/or international jurisdictions.

According to some embodiments, respective sets of suggested song lyrics the first and second sets of suggested song lyrics are based at least in part on output of a neural network; Each suggested song lyric differs from any of the other suggested song lyrics the respective sets.

In some embodiments, the Lyric Engine presents the user's selected plurality of song lyrics in an editing field. The user may further select a subset of the selected plurality of song lyrics displayed by the Lyric Engine in the editing field. The Lyric Engine may receive an update set of suggested song lyrics, generated by a neural network, that correspond to the selected subset of song lyrics from the editing field.

In various embodiments, the Lyric Engine may receive one or more user edits to song lyrics selected by the user.

Further areas of applicability of the present disclosure will become apparent from the detailed description, the claims and the drawings. The detailed description and specific examples are intended for illustration only and are not intended to limit the scope of the disclosure.

### BRIEF DESCRIPTION OF THE DRAWINGS

The present disclosure will become better understood from the detailed description and the drawings, wherein:

FIG. 1A is a diagram illustrating an exemplary environment in which some embodiments may operate.

FIG. 1B is a diagram illustrating an exemplary environment in which some embodiments may operate.

FIG. 1C is a diagram illustrating an exemplary environment in which some embodiments may operate.

FIG. 2 is a diagram illustrating an exemplary method that may be performed in some embodiments.

FIGS. 3A, 3B, 3C, 3D and 3E are each a diagram illustrating an exemplary environment in which some embodiments may operate.

FIGS. 4A, 4B, 4C and 4D are each a diagram illustrating an exemplary environment in which some embodiments may operate.

FIGS. 5A, 5B, 5C and 5D are each a diagram illustrating an exemplary environment in which some embodiments may operate.

FIGS. 6A and 6B are each a diagram illustrating an exemplary environment in which some embodiments may operate.

FIG. 7 is a diagram illustrating an exemplary environment in which some embodiments may operate.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

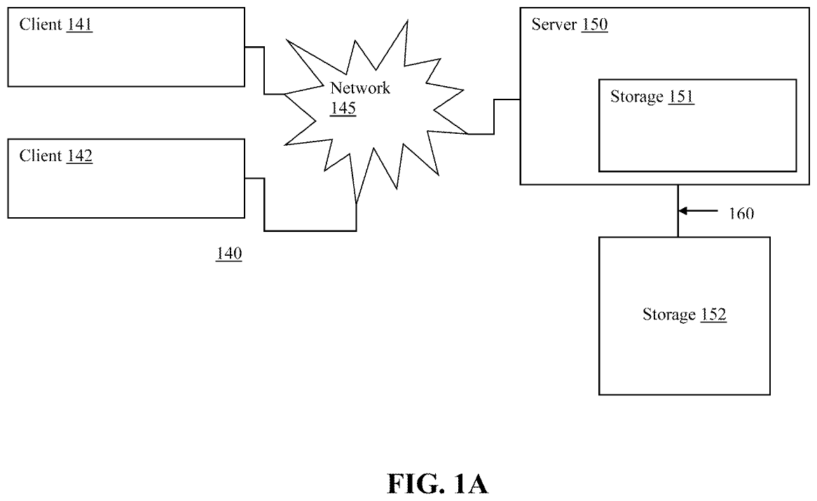

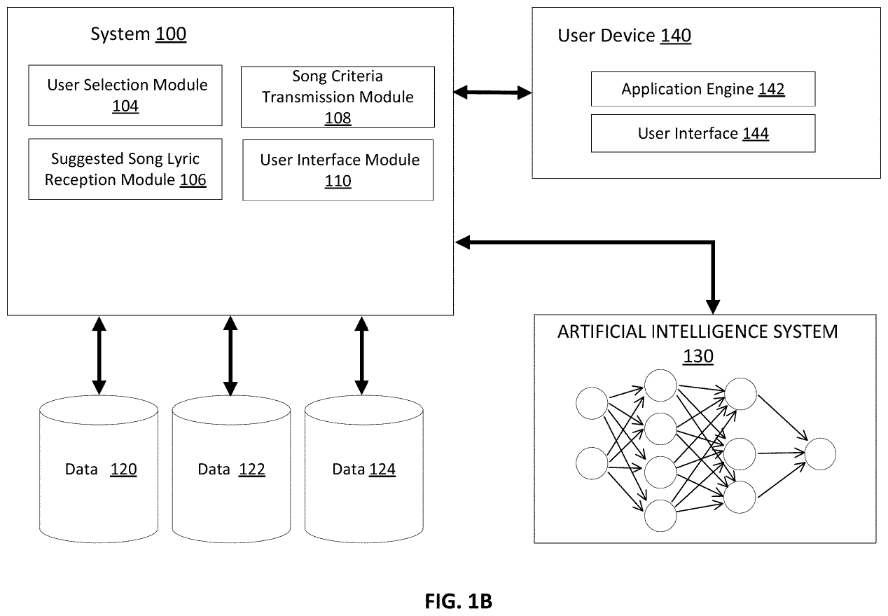

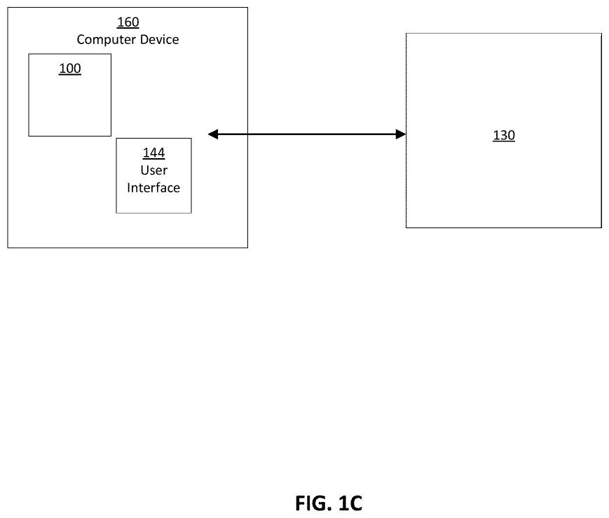

A diagram of exemplary network environment in which embodiments may operate is shown in FIG. 1A. In the exemplary environment 140, two clients 141, 142 are connected over a network 145 to a server 150 having local storage 151. Clients and servers in this environment may be computers. Server 150 may be configured to handle requests from clients.

The exemplary environment 140 is illustrated with only two clients and one server for simplicity, though in practice there may be more or fewer clients and servers. The computers have been termed clients and servers, though clients can also play the role of servers and servers can also play the role of clients. In some embodiments, the clients 141, 142 may communicate with each other as well as the servers. Also, the server 150 may communicate with other servers.

The network 145 may be, for example, local area network (LAN), wide area network (WAN), telephone networks, wireless networks, intranets, the Internet, or combinations of networks. The server 150 may be connected to storage 152 over a connection medium 160, which may be a bus, crossbar, network, or other interconnect. Storage 152 may be implemented as a network of multiple storage devices, though it is illustrated as a single entity. Storage 152 may be a file system, disk, database, or other storage.

In an embodiment, the client 141 may perform the method 200 or other method herein and, as a result, store a file in the storage 152. This may be accomplished via communication over the network 145 between the client 141 and server 150. For example, the client may communicate a request to the server 150 to store a file with a specified name in the storage 152. The server 150 may respond to the request and store the file with the specified name in the storage 152. The file to be saved may exist on the client 141 or may already exist in the server's local storage 151. In another embodiment, the server 150 may respond to requests and store the file with a specified name in the storage 151. The file to be saved may exist on the client 141 or may exist in other storage accessible via the network such as storage 152, or even in storage on the client 142 (e.g., in a peer-to-peer system).

In accordance with the above discussion, embodiments can be used to store a file on local storage such as a disk or on a removable medium like a flash drive, CD-R, or DVD-R. Furthermore, embodiments may be used to store a file on an external storage device connected to a computer over a connection medium such as a bus, crossbar, network, or other interconnect. In addition, embodiments can be used to store a file on a remote server or on a storage device accessible to the remote server.

Furthermore, cloud computing is another example where files are often stored on remote servers or remote storage systems. Cloud computing refers to pooled network resources that can be quickly provisioned so as to allow for easy scalability. Cloud computing can be used to provide software-as-a-service, platform-as-a-service, infrastructure-as-a-service, and similar features. In a cloud computing environment, a user may store a file in the “cloud,” which means that the file is stored on a remote network resource though the actual hardware storing the file may be opaque to the user.

FIG. 1B illustrates a block diagram of an example system 100 for a Lyric Engine that includes a User Selection module 104, a Suggested Song Lyric Reception module 106, a Song Criteria Transmission module 108 and a User Interface (U.I.) module 110. The system 100 may communicate with a user device 140 to display output, via a user interface 144 generated by an application engine 142.

The User Selection module 104 of the system 100 may perform functionality as illustrated in FIGS. 1C, 2, 3A, 3B, 3C, 3D, 3E, 4A, 4B, 4C, 4D, 5A, 5B, 5C, 5D and 6A-6B (“FIGS. 1C-6B”).

The Suggested Song Lyric Reception module 106 of the system 100 may perform functionality illustrated in FIGS. 1C-6B.

The Song Criteria Transmission module 108 of the system 100 may perform functionality illustrated in FIGS. 1C-6B.

The User Interface module 110 of the system 100 may display information, data and user interface options and functionalities based on functionality as illustrated in FIGS. 1C-6B.

While the databases 120, 122 and 124 are displayed separately, the databases and information maintained in a database may be combined together or further separated in a manner the promotes retrieval and storage efficiency and/or data security. It is understood that, in various embodiments, one or more of the modules 104, 106, 108, 110 may reside and be implemented on the user device 140. In addition, respective portions of one or more of the modules 104, 106, 108, 110 may reside and be implemented on the user device 140, while other portions of the same one or more modules 104, 106, 108, 110 may reside and be implemented remotely from the user device 140.

As shown in FIG. 1C, the system 100 may reside within a computing device 160 may implement and execute an instance of the Lyric Engine. The Lyric Engine renders and generates a user interface 144 on the computing device 160. The computing device 160 may communicate one or more user selections with a remote song lyric artificial intelligence system 130.

The Lyric Engine running at computing device 160 may receive respective user selections at the user interface 144. For example, the user selections may indicate one or more types of song criteria. In addition, a user selection may be a selection of a request for a plurality of new suggested song lyrics to be received in an update set of suggested song lyrics.

The Lyric Engine detects respective user selections throughout a song lyric editing session and formats the detected user selections for transmission to the remote song lyric artificial intelligence system 130. The remote song lyric artificial intelligence system 130 generates output based on the detected user selections. According to various embodiments, such output represents suggested song lyrics and/or sets of suggested song lyrics that include content and attributes that correspond with certain user selections. The computing device 160 receives the output from the remote song lyric artificial intelligence system 130 and the Lyric Engine displays the output in the user interface 144.

According to various embodiments, the remote song lyric artificial intelligence system 130 may use and/or be trained according to any suitable machine learning training techniques such as, but not limited to, Artificial Neural Network, Deep Learning; a robust linear regression algorithm, such as Random Sample Consensus, Huber Regression, or Theil-Sen Estimator; a kernel based approach like a Support Vector Machine and Kernel Ridge Regression; a tree-based algorithm, such as Classification and Regression Tree, Random Forest, Extra Tree, Gradient Boost Machine, or Alternating Model Tree; Naïve Bayes Classifier; and other suitable machine learning algorithms. According to various embodiments, the artificial intelligence system 130 may be any type of expert system(s) or may include one or more types of expert systems. According to various embodiments, a database system that provides access to stored lyric portions that can be located and combined according to song/lyric rules may be implemented in place of the artificial intelligence system 130.

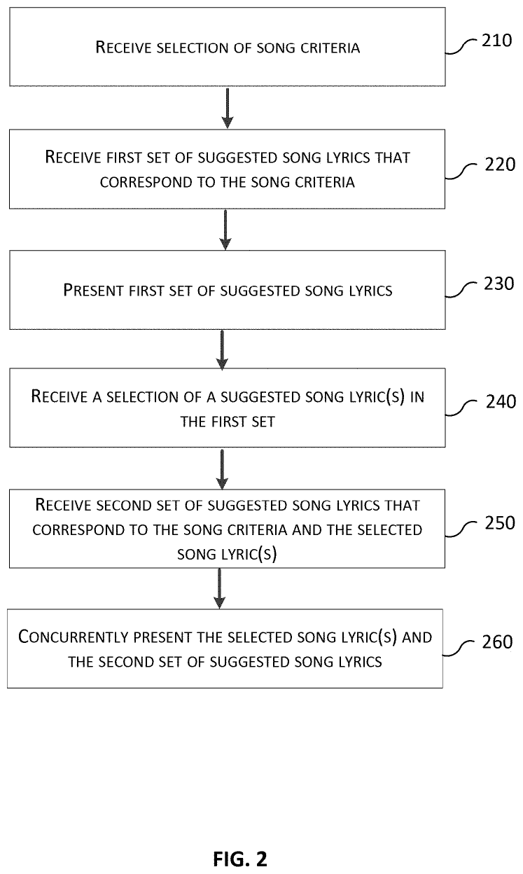

As shown in flowchart 200 of FIG. 2, the Lyric Engine receives, at a user interface, a selection of at least one song criteria (Act 210). According to various embodiments, a song criteria may be based on any type of user selection that occurs during any moment in time during a song lyric editing session. In various embodiments, a song criteria may be based, at least in part, on a selection of one or more of following: a topic, a genre, a user edit, one or more selected song lyrics from a set of suggested song lyrics, a rhyming word(s), a lyric syllable count range, a degree of “wackiness,” and/or various options (“Topic,” “Last Line,” “Topic & Last Line”). In various embodiments, a song criteria may be based, at least in part, on a user-provided song criteria, such as at least one of the following: a user-created topic, a user-created genre, a user-created song lyric(s), a user-created song lyric portions, a user-created rhyming word and/or a user-created lyric syllable count.

The Lyric Engine receives a first set of suggested song lyrics that correspond to the selected song criteria (Act 220). For example, the first set of suggest song lyrics may be generated by and received from a remote neural network. The Lyric Engine presents, in the user interface, the first set of suggested song lyrics (Act 230).

The Lyric Engine receives, at the user interface, a selection of one or more of the suggested song lyrics in the first set (Act 240). For example, the Lyric Engine may detect the user selecting a plurality of suggested song lyrics. In addition, the Lyric Engine may receive user edits to the selected song lyrics.

The Lyric Engine receives a second set of suggested song lyrics that correspond to the selected song criteria and the selected song lyrics (Act 250). For example, the second set of suggest song lyrics may be generated by and received from the remote neural network based, at least in part, on recent activity and selections by the user that occurred after the Lyric Engine displayed the first set of suggested song lyrics. The Lyric Engine concurrently presents, in the user interface, the selected song lyrics and the second set of suggested song lyrics (Act 260). It is understood that various embodiments of the Lyric Engine may be implemented according to an iterative process of continually generating and displaying subsequent sets of suggested song lyrics based on continually updating song criteria or song criteria that has not been updated by the user.

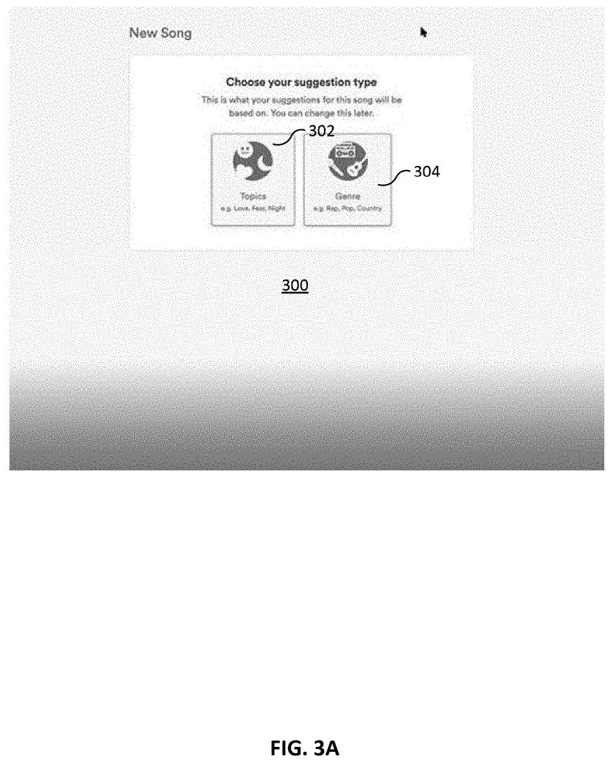

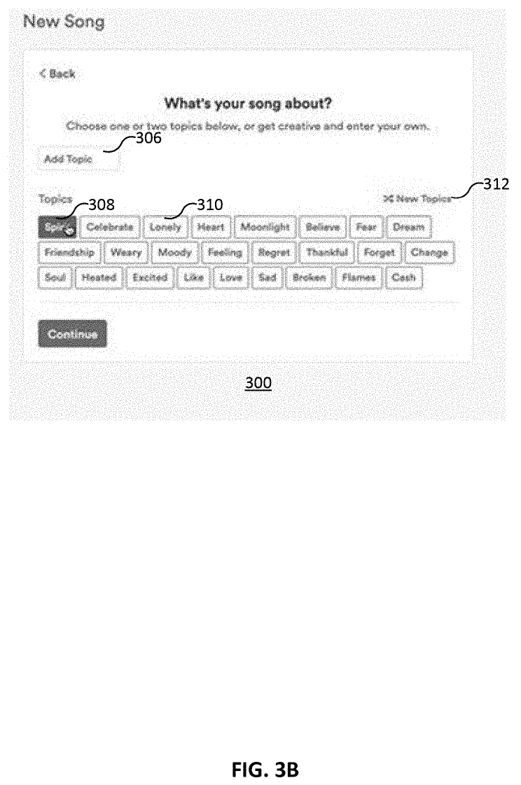

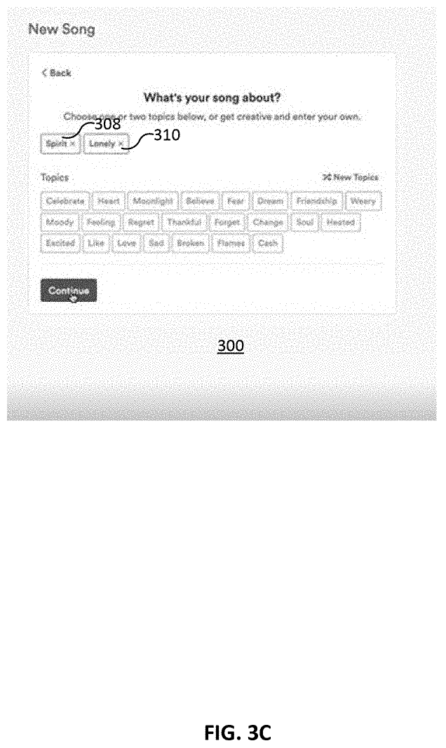

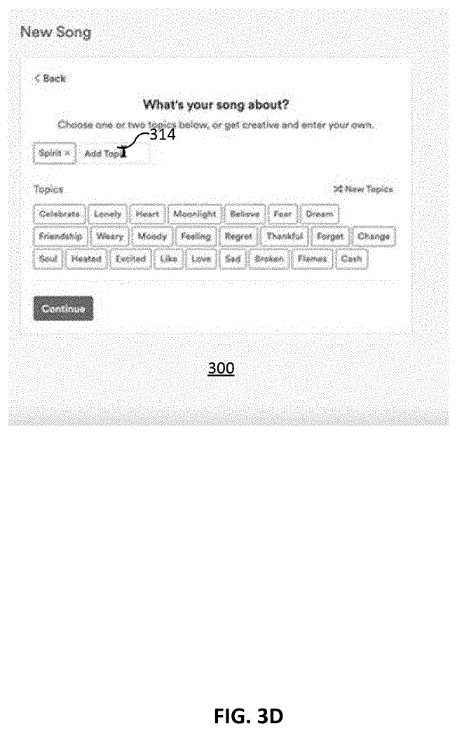

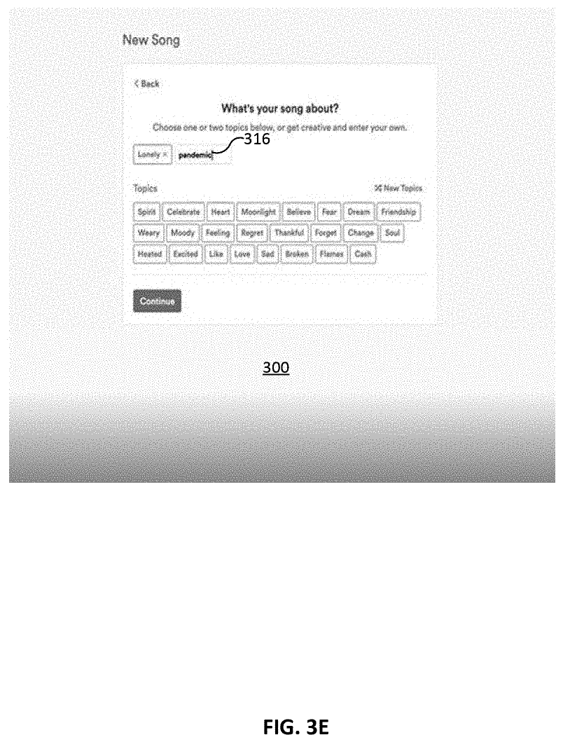

As shown in FIG. 3A, the Lyric Engine presents a user interface 300 that provides functionalities for a user to select a topics functionality 302 and/or a genre functionality 304 upon which suggested song lyrics will be based. As shown in FIG. 3B, in response to detecting the user selecting the topics functionality 302, the user interface 300 displays one or more prompts to the user. The user interface 300 further includes an add topic functionality 306 through which the user may select one or more topics 308, 310 provided by the Lyric Engine. In various embodiments, the Lyric Engine provides a new topics functionality 312. In response to the user selecting the new topics functionality 312, the Lyric Engine updates the user interface 300 with one or more new topics the user may select via the add topic functionality 306. As shown in FIG. 3C, a user may select a plurality of topics 308, 310 upon which suggested song lyrics will be based. For example, a user may desire to create song lyrics for a song that has a topic related to “spirit,” and “lonely.” It is understood that a user may select (or provide, create) any number of topics for a song.

As shown in FIG. 3D, the Lyric Engine provides a topic editing functionality 314 via the user interface 300. As shown in FIG. 3E, the user may input a customized topic 316 for a song. According to various embodiments, a song may have a plurality of topics whereby some of the topics were provided to the user for selection and some of the other topics were provided by the user as customized topics. For example, a user may desire to create song lyrics for a song that has a topic related to “spirit,” and a customized topic of “pandemic.”

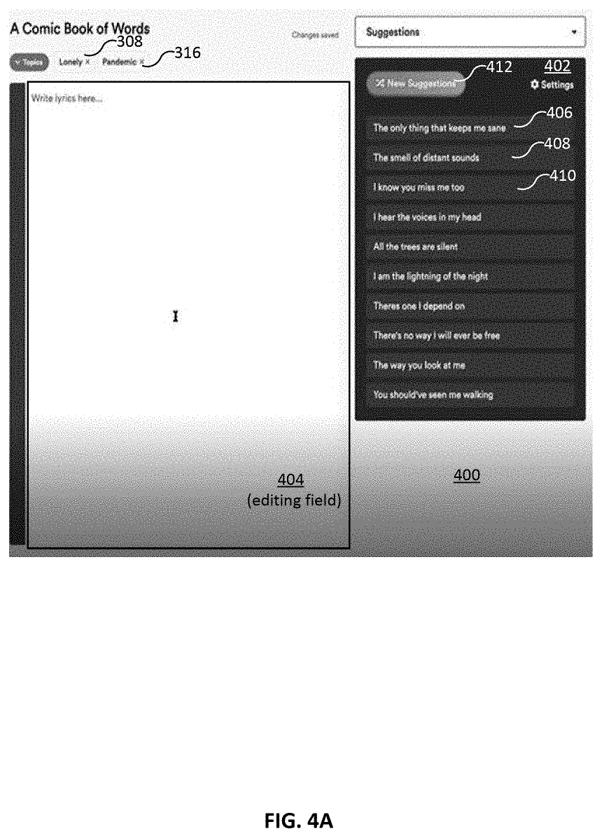

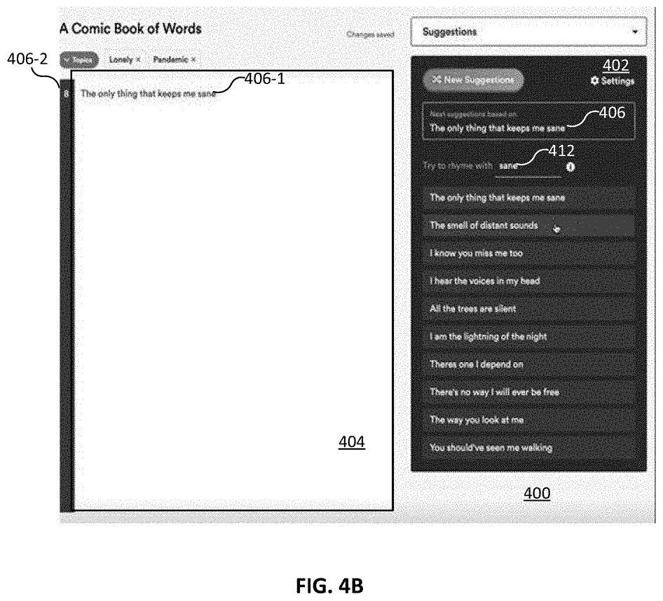

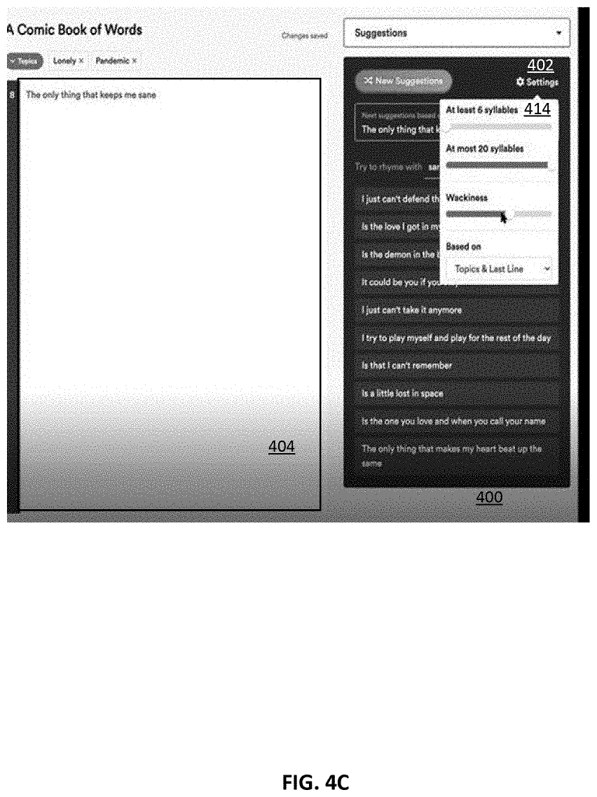

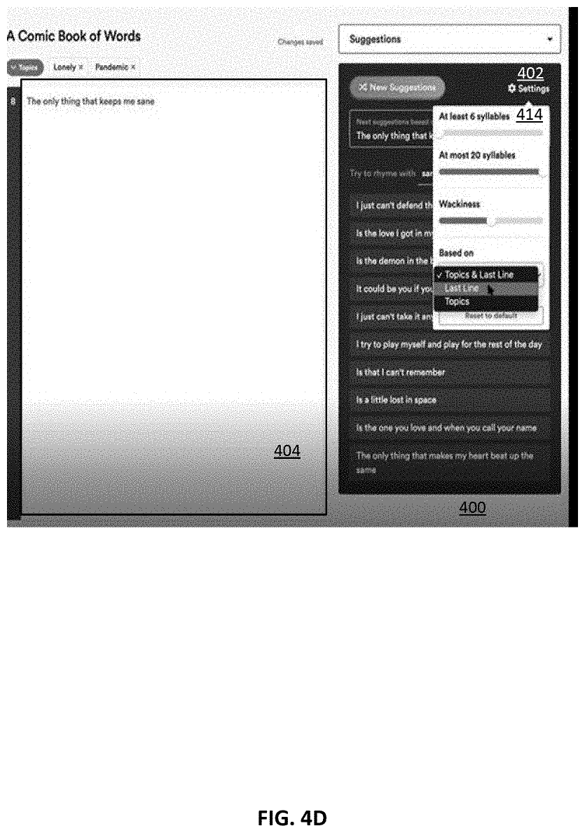

As shown in FIG. 4A, the Lyric Engine may display a user interface 400 that includes a suggested lyric portion 402 and an editing field 404. The Lyric Engine receives a first set of suggested song lyrics (which includes various song lyrics 406, 408, 410) based on one or more topics 308, 316 selected by the user. According to various embodiments, a set of suggested song lyrics may have any number of unique suggested song lyrics, whereby each particular song lyric includes a phrase, phrases or a sequence of words. The suggested song lyrics within a set of suggested song lyrics may differ in length, in word count and/or syllable count.

The suggested lyric portion 402 may further include a new suggestions functionality 412. A user may select the new suggestions functionality 412 and in response to the selection, the Lyric Engine may update the suggested letter portion 402 with one or more new, unique suggested song lyrics or an entirely new set of suggested song lyrics. It is understood that, in one or more embodiments, subsequent sets of suggested song lyrics may include one or more similar words and/or one or more similar phrases. For example, one or more words and/or one or more phrases in a set of suggested song lyrics may also be included in a subsequent set of suggested song lyrics.

As shown in FIG. 4B, the Lyric Engine receives a selection of a suggested song lyric 406 from the suggested lyric portion 402 of the user interface 400. The Lyric Engine displays the selected song lyric 406-1 in the editing field 404. The suggested song lyric portion 402 further indicates that a subsequent set of suggested song lyrics will correspond to the selected song lyric 406. In various embodiments, the suggested lyric portion 402 of the user interface 400 may further provide a rhyming functionality 412 at which a user may indicate a word 412 (“sane”) for rhyming. A subsequent set of suggested lyrics will include lyrics that rhyme with the “sane” but will also correspond to the selected song lyric 406. In addition, the editing field 404 may provide a syllable count indicator 406-2 displayed proximate to a selected song lyric 406. The syllable count indicator 406-2 represents a number of syllable(s) present in a corresponding selected song lyric 406.

As shown in FIG. 4C, the Lyric Engine displays a lyric criteria menu 414 suggested lyric portion 402 of the user interface 400. According to various embodiments, the menu 414 allows a user to select a range of syllable amounts for subsequent sets of suggested song lyrics. For example, a user may select via the menu 414 that a subsequent suggested song lyric may have no less than six syllables and no more than twenty syllables. In various embodiments, the menu 414 may provide a tool for selecting a degree of creativity that will be embodied in subsequent suggested song lyrics. For example, the menu 414 may display a “wackiness” functionality that the user may select and adjust. In various embodiments, a particular adjustment to the “wackiness” functionality by the user results in the Lyric Engine receiving subsequent suggested song lyrics that are highly creative. Such highly creative suggested song lyrics generated by a high setting of the “wackiness” functionality will have a lower likelihood, as determined by one or more artificial intelligence techniques, of being divergent with suggested song lyrics generated according to song criteria (i.e. user selections and/or user provided input). In addition, suggested song lyrics generated by a lower setting of the “wackiness” functionality will have a higher likelihood of being convergent with suggested song lyrics generated according to song criteria.

As shown in FIG. 4D, the menu 414 provides the user with additional functionalities to select one or more additional song criteria. According to various embodiments, the user can select a “Topics” option, a “Last Line” option, “Topics & Last Line” option from the menu 414. Any of these respective options indicate criteria to be used in determining one or more subsequent suggested song lyrics. For example, if the user selects the “Topics” option, the Lyric Engine receives update suggested song lyrics that correspond to one or more song topics the user has currently selected as being applicable to the song for which the user intends to select suggested lyrics. For example, if the user selects the “Last Line” option, the Lyric Engine receives update suggested song lyrics that correspond to a current last selected lyric. For example, if the user has selected four suggested lyrics such that they are displayed in the editing field 404 as four separate lines of lyrics, the fourth lyric line in the editing field 404 will be the last song lyric line utilized for determining subsequent suggested song lyrics upon the user's selection of the “Last Line” option. If the user selects the “Topics & Last Line” option from the menu 414, then subsequent suggested song lyrics will correspond to both the one or more song topics the user has currently selected and the last song lyric line displayed in the editing 414. In various embodiments, the “Last Line” option may correspond to a song lyric most recently selected by the user or a song lyric most recently edited the user.

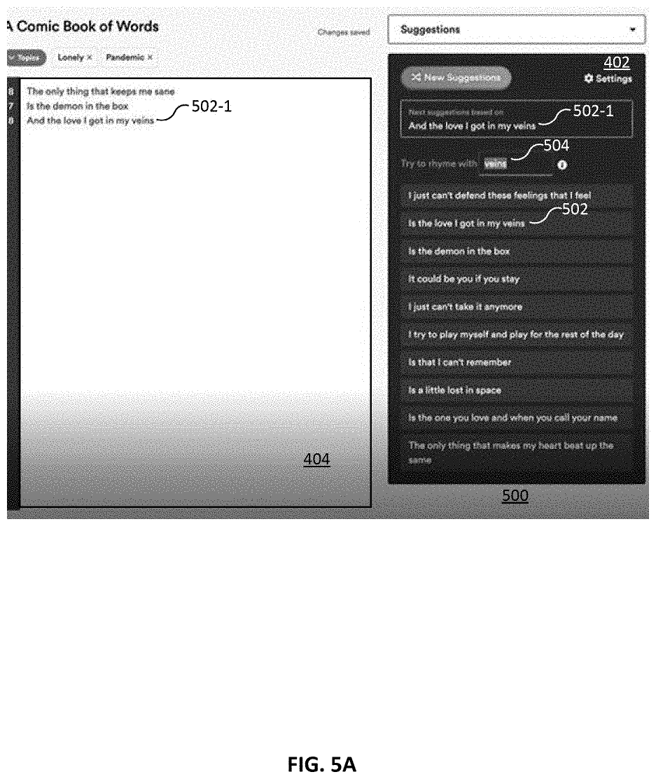

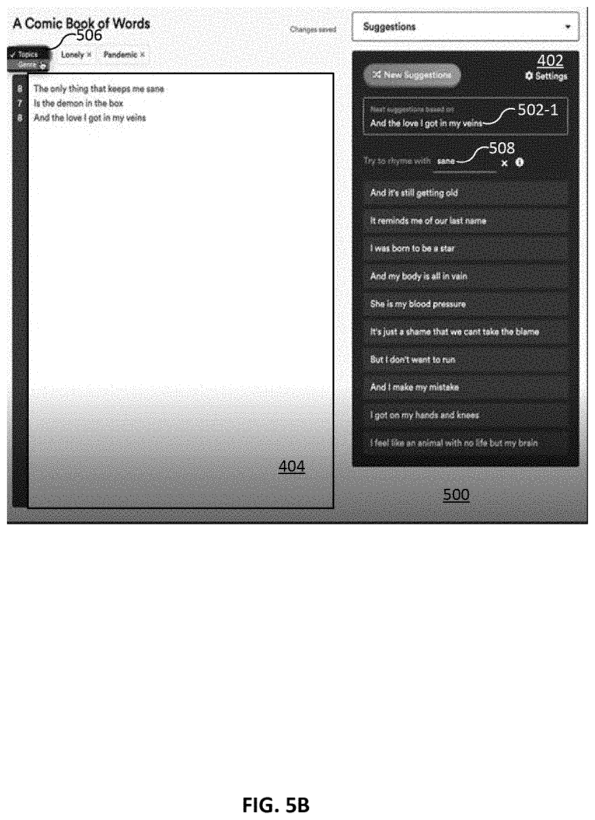

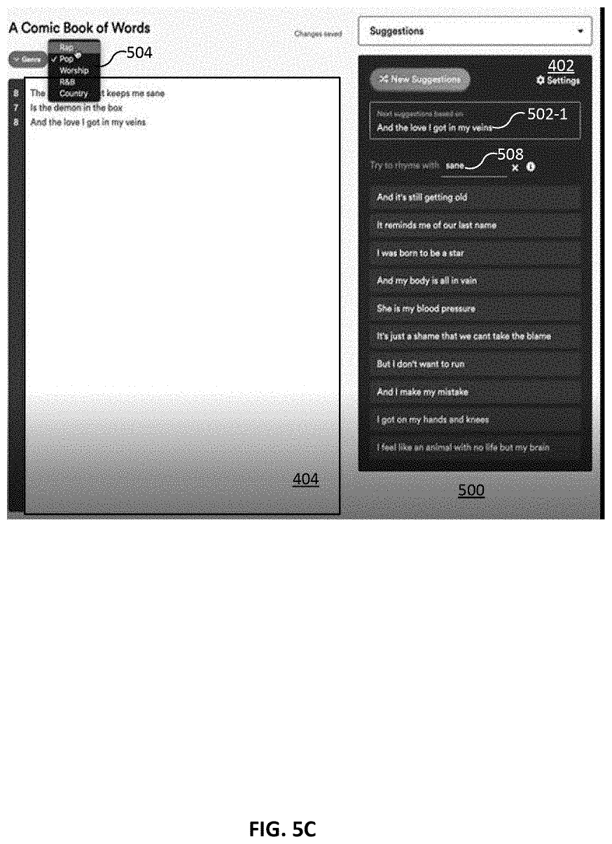

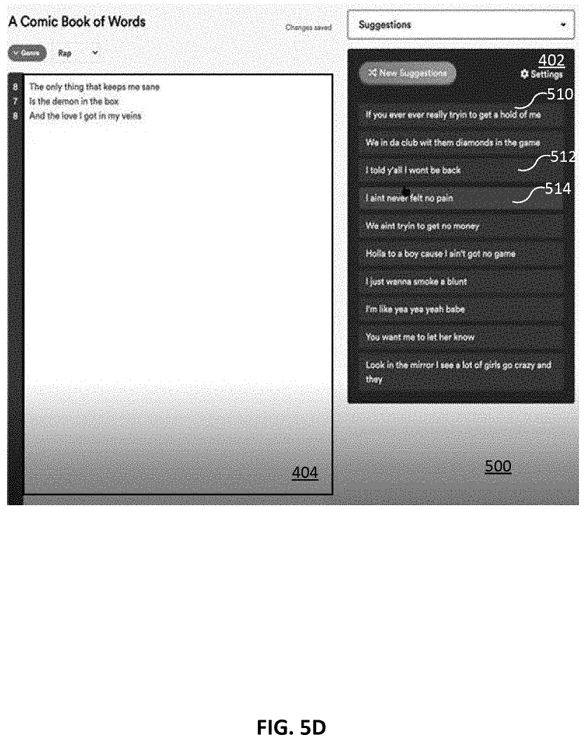

As shown in FIG. 5A, the Lyric Engine receives a selection of a suggested song lyric 502 and the Lyric Engine displays the selected song lyric 502-1 in the editing field 404. The user may select a functionality in the suggested lyric portion 402 of a user interface 500 indicating that subsequent suggested song lyrics should be based on the content and attributes of the selected song lyric 502-1. In various embodiments, the user may select a functionality in the suggested lyric portion 402 that further indicates that a word(s) 504 (“veins”) present in the selected song lyric 502-1 with which subsequent suggested song lyrics may rhyme. According to various embodiments, as shown in FIG. 5B, the Lyric Engine may receive an edit from the user with respect to the word(s) 504 (“veins”) work by the user replaces the word(s) 504 (“veins”) with a different word 508 (“sane”) with which subsequent suggested song lyrics should rhyme. As such, upon receipt of the different word 508 in the suggested lyric portion 402, subsequent suggested song lyrics will correspond to the content and attributes of the particular selected song lyric 502-1 and may rhyme with the recently provided different word 508 (“sane”).

As shown in FIG. 5C, according to various embodiments, during the session in which the user has already selected one or more suggested song lyrics, the Lyric Engine may receive a selection by the user of a particular genre (“Rap”) from a genre menu 504 displayed in the user interface 500. For example, all selected song lyrics displayed in the editing field 404 may have been generated correspond to a previously selected genre (“Pop”). However, upon selection by the user of a new particular genre (“Rap”) from the genre menu 504, subsequent suggested song lyrics received by the Lyric Engine will include content and attributes that correspond to song lyrics from the newly selected particular genre (“Rap”). Further, such subsequent suggested song lyrics may still also correspond to the content and attributes of the particular selected song lyric 502-1 and may rhyme with the recently provided different word 508 (“sane”) as well.

As shown in FIG. 5D, the Lyric Engine receives an update set of suggested song lyrics, which includes various distinct suggested song lyrics 510, 512, 514. Each suggested song. In the update set has content and attributes that correspond to the recently selected “Rap” genre, the content and attributes of the particular selected song lyric 502-1 that may rhyme with the recently provided different word 508 (“sane”).

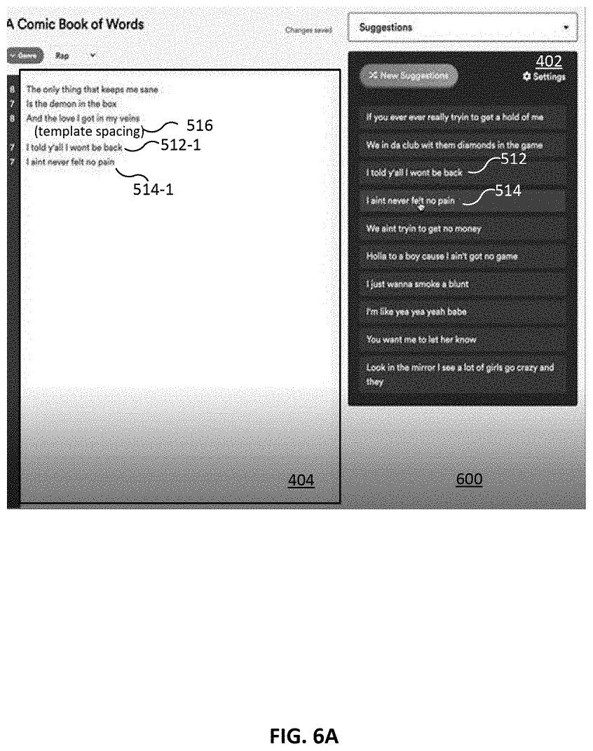

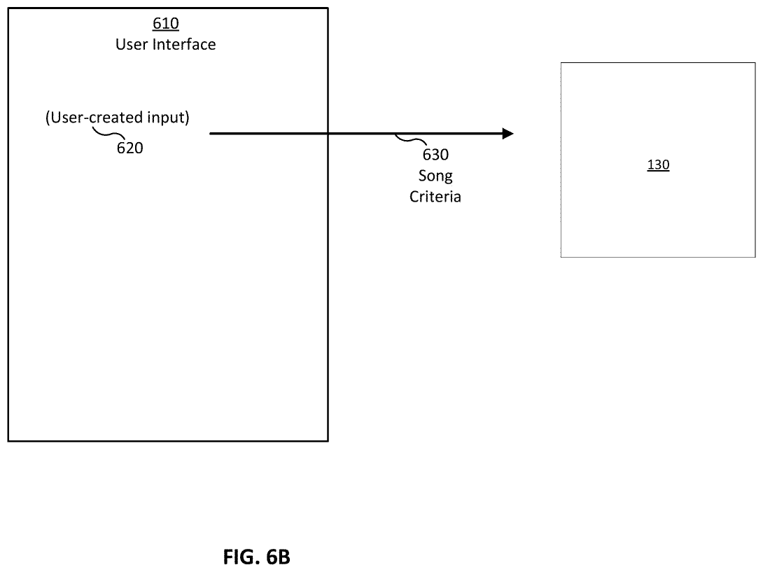

As shown in FIG. 6A, the Lyric Engine receives a user selection of suggested song lyrics 512, 514 displayed in a suggested lyric portion 402 of a user interface 600. Based on the user selection, the Lyric Engine displays the selected song lyrics 512-1, 514-1 in the editing field 404. According to various embodiments, the Lyric Engine displays spacing 516 between groupings of selected song lyrics. According to various embodiments, the Lyric Engine provides the user with a functionality for selection of a particular song lyric template from a plurality of different song their templates. A song lyric template may predefine groupings of song lyrics and/or a predefined sequence of groupings of song lyrics. For example, a song lyric template may organize selected song lyrics according to a verse-chorus form with repeating sections of verse lyrics and chorus lyrics. Spacing 516 displayed by the Lyric Engine in the editing field 404 indicates a transition between different sections of a song lyric template selected by the user.

According to various embodiments, the Lyric Engine may detect the user selecting at the editing field 404 a portion of displayed selected song lyrics. Such selection may represent a portion of a selected song lyric and not all the words of that selected song lyric. For example, the Lyric Engine may receive a user selection of “won't be back” from a selected song their work 512-1. The Lyric Engine may update the song criteria based on the selected song lyric portion (i.e. “won't be back”) such that subsequent suggested song lyrics received by the Lyric Engine may correspond to content and attributes that are associated with the selected song lyric portion (i.e. “won't be back”). In various embodiments, a selected song lyric portion may be an entire sentence, one or more sentences and/or a plurality of disjointed sections from different sentences.

According to various embodiments, a rhyming word selected via the rhyming functionality 412 need not be any word currently displayed to the user. Rather, the user may conceive of the rhyming word and provided to the Lyric Engine as input to the rhyming functionality 412.

According to various embodiments, the user may provide input of a word(s) or a phrase representing a desired ending (or beginning) to a song lyric. The Lyric Engine may utilize the input as a song criteria for generating and providing one or more suggested song lyrics where each suggested song lyric is meant to be used as a word(s) or a phrase at the beginning (or ending) of a song lyric that ends with the user's provided input.

In various embodiments, the user may provide one or more sentences and/or words to be utilized as song criteria for subsequently generated sets of suggested song lyrics. For example, as shown in FIG. 6B, the user may provide as user-created input 620 into a user interface 610 and the Lyric Engine may utilize such user-created input 620 as the song criteria. For example, the user-created input 620 may be one or more words, phrases and/or sentences that are not include in any possible selection choice as described herein. In some embodiments, song criteria may be based solely on user-created input 620.

It is understood that various embodiments are not limited to the generation of song lyrics. For example, one or more embodiments may be implemented for the generation of poetry phrases and/or groupings of sentences.

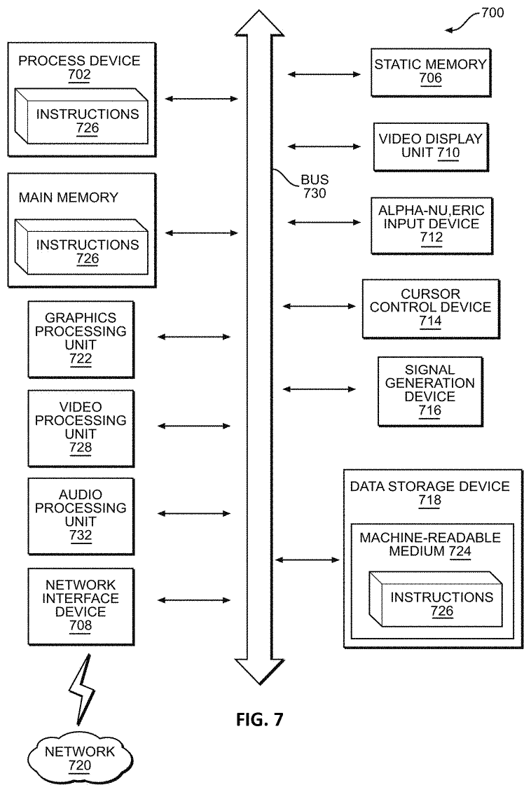

FIG. 7 illustrates an example machine of a computer system within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage device 718, which communicate with each other via a bus 730.

Processing device 702 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein.

The computer system 700 may further include a network interface device 708 to communicate over the network 720. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), a graphics processing unit 722, a signal generation device 716 (e.g., a speaker), graphics processing unit 722, video processing unit 728, and audio processing unit 732.

The data storage device 718 may include a machine-readable storage medium 724 (also known as a computer-readable medium) on which is stored one or more sets of instructions or software 726 embodying any one or more of the methodologies or functions described herein. The instructions 726 may also reside, completely or at least partially, within the main memory 704 and/or within the processing device 702 during execution thereof by the computer system 700, the main memory 704 and the processing device 702 also constituting machine-readable storage media.

In one implementation, the instructions 726 include instructions to implement functionality corresponding to the components of a device to perform the disclosure herein. While the machine-readable storage medium 724 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMS), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A computer-implemented method, comprising:
receiving, at a user interface, a selection of at least one song criteria;
receiving a first set of suggested song lyrics that correspond to the selected song criteria;
presenting, in the user interface, the first set of suggested song lyrics;
receiving, at the user interface, a selection of one or more of the suggested song lyrics in the first set;
receiving a second set of suggested song lyrics that correspond to the selected song criteria and the selected song lyrics; and
concurrently presenting, in the user interface, the selected song lyrics and the second set of suggested song lyrics.

2. The computer-implemented method of claim 1, wherein the first and second sets of suggested song lyrics are based at least in part on output of an artificial intelligence system; and
wherein each suggested song lyric differs from any of the other suggested song lyrics in both the first and second sets.

3. The computer-implemented method of claim 1, wherein receiving, at the user interface, a selection of one or more of the suggested song lyrics in the first set comprises:
receiving, at the user interface, a selection of a plurality of suggested song lyrics from the presented first set of suggested song lyrics;
presenting, in the user interface, the selected plurality of song lyrics in an editing field; and
receiving, at the user interface, a selection of a subset of the selected plurality of song lyrics from the editing field.

4. The computer-implemented method of claim 3, wherein receiving a second set of suggested song lyrics comprises:
receiving an update set of suggested song lyrics, generated by a artificial system, that correspond to the selected subset of song lyrics from the editing field, each respective suggested song lyric in the update set differing from each respective suggested song lyric in the first set; and
concurrently presenting, in the user interface, the update set of suggested song lyrics and the selected subset of song lyrics in the editing field.

5. The computer-implemented method of claim 4, wherein receiving, at the user interface, a selection of a subset of the selected plurality of song lyrics from the editing field comprises:
receiving, at the user interface, a selection of at least one additional song criteria for the update set of suggested song lyrics;
presenting, in the user interface, a representation of the selected additional song criteria; and
wherein the update set of the suggest lyrics comprises multiple, distinct phrases based at least in part on output from a remote artificial intelligence system, the output based on the at least one additional song criteria and the selected subset in the editing field.

6. The computer-implemented method of claim 1, wherein selecting, from the user interface, one or more of the suggested song lyrics in the first set comprises:
receiving a user input comprising at least one user edit to at least a portion of the selected song lyrics or user-created input in place of a selection of a suggested song lyric;
presenting the user input; and
wherein receiving the second set of suggested song lyrics comprises:
receiving an update set of suggested song lyrics that corresponds at least in part on the user input.

7. The computer-implemented method of claim 1, wherein receiving, at the user interface, a selection of one or more of the suggested song lyrics in the first set comprises:
receiving, at the user interface, a user-selected word present in the selected song lyrics; and
wherein receiving a second set of suggested song lyrics that correspond to the selected song criteria and the selected song lyrics further comprises:
receiving an update set of suggested song lyrics, wherein each suggested song lyric in the update set includes at least one of a type of word, wherein the type of word comprises:
(i) a word that rhymes with the user-selected word present in the selected song lyrics;
(ii) the user-selected word; or
(iii) a word provided by the user.

8. A system comprising one or more processors, and a non-transitory computer-readable medium including one or more sequences of instructions that, when executed by the one or more processors, cause the system to perform operations comprising:
receiving, at a user interface, a selection of at least one song criteria;
receiving a first set of suggested song lyrics that correspond to the selected song criteria;
presenting, in the user interface, the first set of suggested song lyrics;
receiving, at the user interface, a selection of one or more of the suggested song lyrics in the first set;
receiving a second set of suggested song lyrics that correspond to the selected song criteria and the selected song lyrics; and
concurrently presenting, in the user interface, the selected song lyrics and the second set of suggested song lyrics.

9. The system of claim 8, wherein the first and second sets of suggested song lyrics are based at least in part on output of a artificial intelligence system; and
wherein each suggested song lyric differs from any of the other suggested song lyrics in both the first and second sets.

10. The system of claim 8, wherein receiving, at the user interface, a selection of one or more of the suggested song lyrics in the first set comprises:
receiving, at the user interface, a selection of a plurality of suggested song lyrics from the presented first set of suggested song lyrics;
presenting, in the user interface, the selected plurality of song lyrics in an editing field; and
receiving, at the user interface, a selection of a subset of the selected plurality of song lyrics from the editing field.

11. The system of claim 10, wherein receiving a second set of suggested song lyrics comprises:
receiving an update set of suggested song lyrics, generated by a artificial intelligence system,
that correspond to the selected subset of song lyrics from the editing field, each respective suggested song lyric in the update set differing from each respective suggested song lyric in the first set; and
concurrently presenting, in the user interface, the update set of suggested song lyrics and the selected subset of song lyrics in the editing field.

12. The system of claim 11, wherein receiving, at the user interface, a selection of a subset of the selected plurality of song lyrics from the editing field comprises:
receiving, at the user interface, a selection of at least one additional song criteria for the update set of suggested song lyrics;
presenting, in the user interface, a representation of the selected additional song criteria; and
wherein the update set of the suggest lyrics comprises multiple, distinct phrases based at least in part on output from a remote artificial intelligence system, the output based on the at least one additional song criteria and the selected subset in the editing field.

13. The system of claim 8, wherein selecting, from the user interface, one or more of the suggested song lyrics in the first set comprises:
receiving a user edit to at least a portion of the selected song lyrics;
presenting the user edited portion of the selected song lyrics; and
wherein receiving the second set of suggested song lyrics comprises:
receiving an update set of suggested song lyrics that correspond to the selected song criteria, the selected song lyrics and the user edited portion of the selected song lyrics.

14. The system of claim 8, wherein receiving, at the user interface, a selection of one or more of the suggested song lyrics in the first set comprises:
receiving, at the user interface, a user-selected word present in the selected song lyrics; and
wherein receiving a second set of suggested song lyrics that correspond to the selected song criteria and the selected song lyrics further comprises:
receiving an update set of suggested song lyrics, wherein each suggested song lyric in the update set includes a particular word that rhymes with the user-selected word present in the selected song lyrics.

15. A computer program product comprising a non-transitory computer-readable medium having a computer-readable program code embodied therein to be executed by one or more processors, the program code including instructions for:
receiving, at a user interface, a selection of at least one song criteria;
receiving a first set of suggested song lyrics that correspond to the selected song criteria;
presenting, in the user interface, the first set of suggested song lyrics;
receiving, at the user interface, a selection of one or more of the suggested song lyrics in the first set;
receiving a second set of suggested song lyrics that correspond to the selected song criteria and the selected song lyrics; and
concurrently presenting, in the user interface, the selected song lyrics and the second set of suggested song lyrics.

16. The computer program product of claim 15, wherein the first and second sets of suggested song lyrics are based at least in part on output of a artificial intelligence system; and
wherein each suggested song lyric differs from any of the other suggested song lyrics in both the first and second sets.

17. The computer program product of claim 15, wherein receiving, at the user interface, a selection of one or more of the suggested song lyrics in the first set comprises:
receiving, at the user interface, a selection of a plurality of suggested song lyrics from the presented first set of suggested song lyrics;
presenting, in the user interface, the selected plurality of song lyrics in an editing field; and
receiving, at the user interface, a selection of a subset of the selected plurality of song lyrics from the editing field.

18. The computer program product of claim 17, wherein receiving a second set of suggested song lyrics comprises:
receiving an update set of suggested song lyrics, generated by a artificial intelligence system,
that correspond to the selected subset of song lyrics from the editing field, each respective suggested song lyric in the update set differing from each respective suggested song lyric in the first set; and
concurrently presenting, in the user interface, the update set of suggested song lyrics and the selected subset of song lyrics in the editing field.

19. The computer program product of claim 18, wherein receiving, at the user interface, a selection of a subset of the selected plurality of song lyrics from the editing field comprises:
receiving, at the user interface, a selection of at least one additional song criteria for the update set of suggested song lyrics;
presenting, in the user interface, a representation of the selected additional song criteria; and
wherein the update set of the suggest lyrics comprises multiple, distinct phrases based at least in part on output from a remote artificial intelligence system, the output based on the at least one additional song criteria and the selected subset in the editing field.

20. The system of claim 15, wherein selecting, from the user interface, one or more of the suggested song lyrics in the first set comprises:
receiving a user edit to at least a portion of the selected song lyrics;
presenting the user edited portion of the selected song lyrics; and
wherein receiving the second set of suggested song lyrics comprises:
receiving an update set of suggested song lyrics that correspond to the selected song criteria, the selected song lyrics and the user edited portion of the selected song lyrics.
